(19) United States
(12) Patent Application Publication
(10) Pub. No.: US 2025/0260182 A1
(43) Pub. Date: Aug. 14, 2025

(54) Contact support, electrical connector insert and electrical connector

(71) Applicant: HARTING Electric Stiftung & Co. KG, Espelkamp (DE)

(72) Inventors: Markus WITTPAHL, Hüllhorst (DE); Norbert KROPIEWNICKI, Bielefeld (DE)

(73) Assignee: HARTING Electric Stiftung & Co. KG, Espelkamp (DE)

(21) Appl. No.: 18/856,294

(22) PCT Filed: Mar. 31, 2023
(86) PCT No.: PCT/DE2023/100249

§ 371 Date: Oct. 11, 2024

(30) Foreign Application Priority Data
Apr. 14, 2022 (DE) 10 2022 109 238.0

(51) Int. Cl. H01R 4/48

(52) U.S. Cl. CPC H01R 4/4811

(57) ABSTRACT

A contact support includes a bus bar and a contact spring, which has a clamping leg for clampingly contacting an electrical conductor between the clamping leg and a contact surface on the bus bar. The contact spring has a mounting leg for permanently fixing the contact spring on a fastening surface of the bus bar, the mounting leg being connected to the clamping leg. A snap element is formed on the mounting leg. A counter-surface is formed on the fastening surface such that, when the mounting leg is fixed on the fastening surface, the snap element engages behind the counter-surface to close a snap connection. When the snap connection is closed, a stop disposed on the mounting leg is firmly seated against a counter-stop formed on the fastening surface and eliminates longitudinal movability of the mounting leg relative to the fastening surface.

### CROSS-REFERENCE TO RELATED APPLICATION

This application is a national stage application, filed under 35 U.S.C. § 371, of International Patent Application PCT/DE2023/100249, filed on Mar. 31, 2023, which claims the benefit of German Patent Application DE 10 2022 109 238.0, filed on Apr. 14, 2022.

### BACKGROUND

The disclosure relates to a contact support, a plug connector insert, and a plug connector. A contact support consists for its part of an electrically conductive busbar and a contact spring. The busbar serves as an electric conducting element between an electrical line and contact elements or the like. Electrical lines consist for their part of individual electrical wires, bundled to form an electrical conductor, and of one or more insulating sheaths surrounding these wires. The insulating sheaths are stripped at the end of the electrical line in order to connect the bundled wires at the busbar. If the wires can bend slightly, a wire-end sleeve is pushed over the wires in order to be able to connect a dimensionally stable line end to the busbar. As an alternative to bundled wires, electrical conductors which are all in the form of solid conductors are also equally included in connection with this disclosure.

The contact spring serves to fix the stripped wires, or the wires pushed into a wire-end sleeve, in clamping fashion. The contact spring generally has a clamping leg which can pivot resiliently toward a contact surface formed on the busbar. If the clamping leg is moved away from the contact surface, a clamping space is opened up for the stripped wires to be connected or for the wire-end sleeve. The clamping leg can be pivoted away from the contact surface by the wire-end sleeve when the conductor is inserted and thus the clamping space is opened up for a short period of time until the wire-end sleeve has assumed its final connection position relative to the contact surface. This is referred to here as a “push-in” contact.

The contact spring furthermore also has a mounting leg connected to the clamping leg. The contact spring is mounted, i.e. is fastened, on a fastening surface of the busbar by this mounting leg. According to the internal prior art of the local applicant, a mounting window is cut free in the mounting leg of the contact spring. A tab protruding from the fastening surface of the busbar engages in this mounting window and thus forms as it were a suspension for the contact spring on the busbar. This suspension is, however, not free of play.

Because the prefabricated contact supports are generally transported and handled as bulk goods, undesired detachment of the contact spring from the busbar cannot be excluded. Because of the play in the suspension, the contact spring can also undesirably be tilted relative to the busbar, which generally goes unnoticed and can later cause the failure of the contact support.

A search by the German Patent and Trademark Office has found the following prior art in the priority application for the present application: DE 19 17 503 B2, DE 10 2015 108 630 A1, DE 10 2021 105 734 A1, DE 20 2017 006 317 U1, and EP 3 375 045 B1.

### SUMMARY

The present disclosure improves the seating of the contact spring on the busbar by fixing it more firmly. This is achieved by the contact support, the plug connector insert, and the plug connector as disclosed herein.

The disclosure is based on the fundamental concept of fixing the contact spring on the busbar with a snap connection. Such snap connections are known, for example, from “BAUER—Handbuch der Verbindungstechnik [Manual of Joining Technology]; Hanser Verlag, Munich, Vienna, 1991-ISBN 3-446-14609-1, p. 294 ff.”. It is common to snap connections that a projecting point of a part, for example a hook or a bulge, is deflected for a short period of time during fitting and latches into, for example, a depression (undercut) of the connection partner. A catch, referred to below as a snap element, is formed on the mounting leg of the contact spring and interacts with a mating surface formed on the fastening surface of the busbar and adapted to the catch as a snap connection.

For the purpose of improved fixing of the contact spring on the busbar, also formed on the catch or snap element is a stop which, when the snap connection is closed with the snap element snapped against the mating surface, bears firmly against a mating stop formed on the fastening surface.

In this way, busbars and contact springs can be joined together simply, securely, and cost-effectively during the prefabrication or component manufacture. In the final fitted state with a closed snap connection, because of the interaction of the stop and the mating stop, the ability of the contact spring to move longitudinally along the busbar is effectively cancelled and fixes the contact spring in a form-fitting fashion and firmly on the busbar by virtue of the snap connection.

The contact surface and the fastening surface on the busbar are expediently a constituent part of a contact cage with a rectangular hollow cross-section. Such a contact cage favors a compact structure of the contact support and is particularly well suited to securely and reliably removing the high clamping forces. In addition, the cage walls or cage side walls can fulfil further functions or mount technical components.

In an advantageous development, a guide surface is situated in front of the fastening surface on the busbar. The two surfaces preferably run parallel to each other and, in the fitted state of the contact support with the snap connection closed, receive the mounting leg of the contact spring between them and thus additionally guide the mounting leg on the busbar. The two surfaces expediently flank the mounting leg in the manner of clamping jaws when the snap connection is closed. A first embodiment of the contact support comprises a T-shaped tab bent out of the fastening surface essentially at right angles. The inner side, facing the fastening surface, of the T cross-piece formed in the manner of a hammer head here forms the guide surface for the mounting leg of the contact spring. The T longitudinal piece forming a neck between the hammer head and the fastening surface forms with its underside the mating surface for the snap connection and with its upper side the mating stop for the snap connection.

The free end of the mounting leg of the contact spring is slotted by means of a V-shaped slot. The V-shaped slot is widened toward the free end of the mounting leg and tapers in the direction of a preferably rectangular mounting eye, cut out from the mounting leg, in such a way that the slot merges as it were, with its narrow end, with the mounting eye. The V-shaped contour of the slot forms an insertion slope for the mounting leg with which the mounting leg is pushed in its longitudinal direction over the neck of the T-shaped tab during the fitting. Adjoining the V-shaped contour is a straight slot region running in the longitudinal direction of the mounting leg. This straight slot region merges with the mounting eye. The lower edge of the mounting eye is divided centrally by the straight slot region and forms two snap surfaces which run in each case at right angles to the slot. These snap surfaces, the straight slot region, and the adjoining V-shaped slot region thus form the separation gap between two snap hooks at the lower end of the mounting leg.

In the final fitted position of the mounting leg, the neck of the T-shaped tab completely fills the mounting eye. The two snap surfaces, running in each case at right angles to the slot, of the snap hooks here engage behind the underside of the neck as a mating surface of the snap connection. The resilient snap hooks form the snap elements of this snap connection.

The upper edge, situated opposite the snap surfaces and running parallel to the snap surfaces, of the mounting eye bears firmly against the upper edge of the neck of the T-shaped tab as a mounting leg stop. The upper edge of the neck thus forms the mating stop on the fastening surface of the contact spring. The snap hooks bearing firmly against the mating surface and the stop, bearing firmly against the mating stop, of the mounting eye thus fix the mounting leg in its final fitted position on the fastening surface. The inner side, facing the fastening surface, of the hammer head here bears against the mounting leg of the contact spring as an additional guide surface. The guide surface and the fastening surface thus guide the mounting leg between them.

A second embodiment of the contact support comprises in a basic variant a latching window cut free from the fastening surface of the busbar. A latching tab corresponding to this latching window in the final fitted state is bent out of the mounting leg of the contact spring as a snap element. The mounting leg is pushed during the fitting simply along the fastening surface until the latching tab snaps into the latching window and the upper rim of the latching tab engages behind the upper edge of the latching window as a mating surface on the fastening surface. The end side of the free end of the mounting leg bears in this final fitted position as a stop of the mounting leg against a mating stop bent out from the lower edge of the fastening surface.

Lastly, a guide lug is in each case bent out in the direction of the cage interior from each of the two cage side walls which connect the contact surface and the fastening surface of the busbar in each case at the edge and form the contact cage in conjunction with said surfaces. The surface, facing the fastening surface of the busbar, of the guide lugs in each case forms a guide surface. In the final fitted state with the latching tab snapped into the latching window, these guide surfaces and the fastening surface of the busbar flank the mounting leg of the contact spring between them and as it were clamp it between them.

A variant of the second embodiment which is a modification of this basic variant has in each case, formed in pairs, two latching windows which are cut free at the edge from the fastening surface and correspondingly in each case two latching tabs bent out at the edges on the mounting leg as snap elements. The guide lugs with the guide surfaces of the basic variant are preserved unchanged in the modified variant.

In a development of all the embodiments and their variants, contact pins or contact sockets are attached and connected in a manner known per se on the busbar. These contact pins and contact sockets serve as electrical and mechanical coupling elements of a plug coupling and develop the contact support to form a plug connector insert. This plug connector insert can be inserted into a corresponding insulating housing and thus developed to form a plug connector.

### BRIEF DESCRIPTION OF THE DRAWINGS

The invention is explained in detail on the basis of the exemplary embodiments reproduced in the drawings, in which:

FIG. 1 shows a perspective view of the contact cage of a first embodiment,

FIG. 2 shows a perspective of the associated contact spring of this first embodiment,

FIG. 3 shows a perspective view in partial section of the first embodiment of the contact support,

FIG. 4 shows a perspective view of the contact cage of the basic variant of a second embodiment,

FIG. 5 shows a perspective view of the associated contact spring of this basic variant of the second embodiment,

FIG. 6 shows a perspective view in partial section of this basic variant of the second embodiment of the contact support,

FIG. 7 shows a perspective view of the contact cage of a modified variant of the second embodiment,

FIG. 8 shows a perspective view of the associated contact spring of this modified variant of the second embodiment, and

FIG. 9 shows a perspective view in partial section of this modified variant of the second embodiment of the contact support.

### DETAILED DESCRIPTION

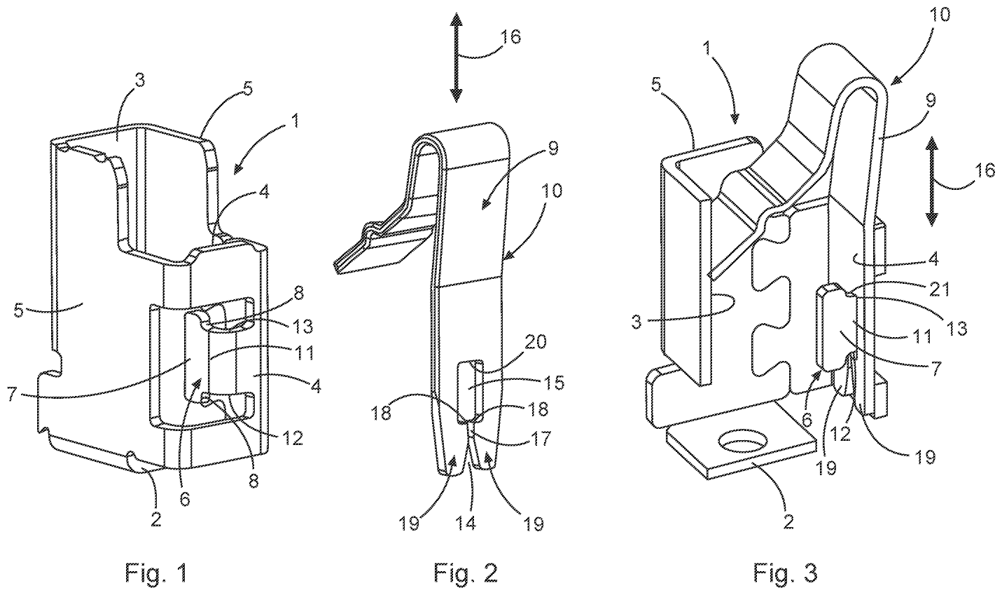

FIG. 1 shows a contact cage 1 as a constituent part of a busbar 2 with a contact surface 3 and with a fastening surface 4 on the busbar. This contact cage 1 has a rectangular hollow cross-section. The contact surface 3 and the fastening surface 4 form a front and a rear cage wall of the contact cage 1. These cage walls are connected to each other at their edges by cage side walls 5 running at right angles to the cage walls and form the rectangular hollow cross-section of the contact cage 1 in conjunction with said cage side walls.

In a first embodiment of the contact support illustrated in FIG. 3, a T-shaped tab 6 is bent out from the fastening surface 4 essentially at right angles. The inner side, facing the fastening surface 4, of the T cross-piece formed in the manner of a hammer head 7 here forms a guide surface 8 for a mounting leg 9 of a contact spring 10 illustrated in FIG. 2. The T longitudinal piece forming a neck 11 between the hammer head 7 and the fastening surface 4 forms with its underside a mating surface 12 for a snap connection and with its upper side a mating stop 13 for this snap connection.

The free end of the mounting leg 9 of the contact spring 10 is slotted by means of a V-shaped slot 14. The V-shaped slot 14 is widened toward the free end of the mounting leg and tapers in the direction of a rectangular mounting eye 15, cut out from the mounting leg, in such a way that the slot 14 merges as it were, with its narrow end, with the mounting eye 15. The V-shaped contour of the slot 14 forms an insertion slope for the mounting leg 9, by means of which the mounting leg 9 is pushed in its longitudinal direction 16 over the neck 11 of the T-shaped tab 6 during the fitting.

Adjoining the V-shaped contour is a straight slot region 17 running in the longitudinal direction 16 of the mounting leg 9. This straight slot region 17 merges with the mounting eye 15. The lower edge of the mounting eye 15 is divided centrally by the straight slot region 17 and forms two snap surfaces 18 which run in each case at right angles to the slot 14. These snap surfaces 18, the straight slot region 17, and the adjoining V-shaped widened slot 14 thus form the separation gap between two resilient snap hooks 19 at the lower end of the mounting leg 9 of the contact spring 10.

In the final fitted position of the mounting leg 9, the neck 11 of the T-shaped tab 6 completely fills the mounting eye 15 in the mounting leg 9. The two snap surfaces 18, running in each case at right angles to the slot 14, of the snap hooks 19 engage behind the underside of the neck 11 as a mating surface 12 of a snap connection. The snap hooks 19 form the snap elements of this snap connection.

The upper edge, situated opposite the snap surfaces 18 in the longitudinal direction 16 and running parallel to the snap surfaces 18, of the mounting eye 15 bears firmly against the upper edge of the neck 11 of the T-shaped tab 6 as a mounting leg stop 20. The upper edge of the neck 11 thus forms the mating stop 13 on the fastening surface 4 of the contact spring 10. The snap hooks 19 bearing firmly against the mating surface 12 and the stop 20, bearing firmly against the mating stop 13, of the mounting eye 15 thus fix the mounting leg 9 in its final fitted position on the fastening surface 4. The inner side, facing the fastening surface 4, of the hammer head 7 here bears against the mounting leg 9 of the contact spring 10 as an additional guide surface 8. The guide surface 8 and the fastening surface 4 thus guide the mounting leg 9 between them.

A second embodiment, illustrated in FIG. 6, of the contact support comprises in a basic variant a latching window 21 cut free from the fastening surface 4 of the busbar 2. A latching tab 22 corresponding to this latching window 21 in the final fitted state is bent out of the mounting leg 9 of the contact spring 10 shown in FIG. 5 as a snap element. The mounting leg 9 is pushed during the fitting simply along the fastening surface 4 in the longitudinal direction 16 until the latching tab 22 snaps into the latching window 21 and the upper rim of the latching tab 22 engages behind the upper edge of the latching window 21 as a mating surface 12. The end side of the free end of the mounting leg 9 bears in this final fitted position as a stop 20 of the mounting leg 9 against a mating stop 13 bent out from the lower edge of the fastening surface 4.

Lastly, a guide lug 23 is in each case bent out in the direction of the cage interior from each of the two cage side walls 5 which connect the contact surface 3 and the fastening surface 4 of the busbar 10 in each case at the edge and form the contact cage 1 in conjunction with said surfaces. The surface, facing the fastening surface 4 of the busbar 10, of the guide lugs 23 in each case forms a guide surface 8. In the final fitted state with the latching tab 22 snapped into the latching window 21, these guide surfaces 8 and the fastening surface 4 of the busbar 2 flank the mounting leg 9 of the contact spring 10 in each case and as it were clamp it between them.

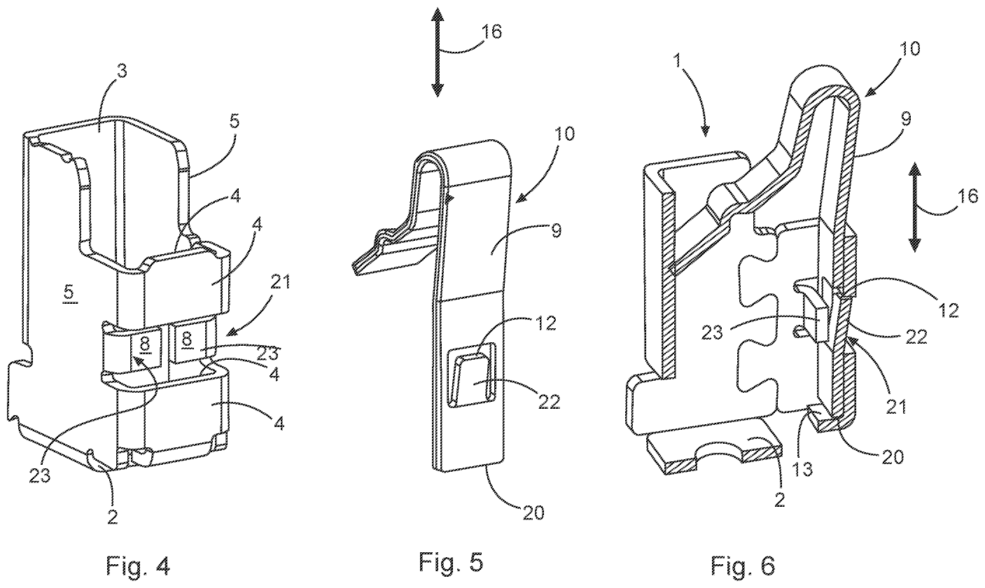

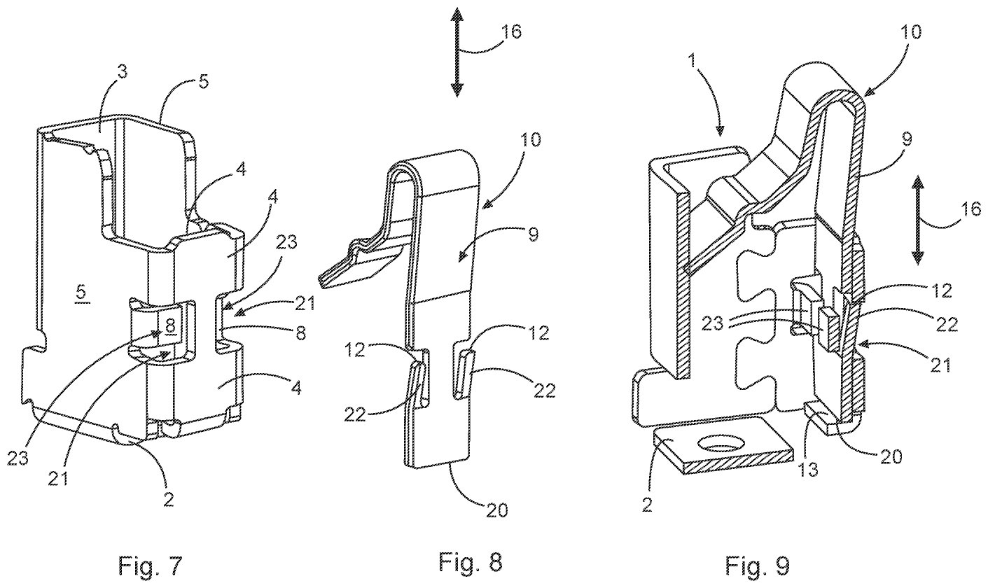

A variant of the second embodiment which is modified from the basic variant according to FIG. 4, FIG. 5, and FIG. 6 is shown in FIG. 7, FIG. 8, and FIG. 9. The contact support shown there has in each case, formed in pairs, two latching windows 21 which are cut free at the edge from the fastening surface 4 and correspondingly in each case two latching tabs 22 bent out at the edges on the mounting leg 9 as snap elements. The guide lugs 23 with the guide surfaces 8 of the basic variant according to FIG. 4, FIG. 5, and FIG. 6 are preserved unchanged in the modified variant.

### LIST OF REFERENCE SIGNS

1 contact cage
2 busbar
3 contact surface
4 fastening surface
5 cage side wall
6 tab
7 hammer head
8 guide surface
9 mounting leg
10 contact spring
11 neck
12 mating surface
13 mating stop
14 slot
15 mounting eye
16 longitudinal direction
17 straight slot region
18 snap surface
19 snap hook
20 stop
21 latching window
22 latching tab
23 guide lug

1.-9. (canceled)

10. A contact support, comprising:
a busbar (2); and
a contact spring (10)
with a clamping leg for contacting in clamping fashion an electrical conductor between the clamping leg and a contact surface (3) on the busbar (2) and
with a mounting leg (9) connected to the clamping leg in order to permanently fix the contact spring (10) on a fastening surface (4) of the busbar (2),
wherein a snap element is formed on the mounting leg (9), and
wherein a mating surface (12) interacting with the snap element is formed on the fastening surface (4) in such a way that the snap element engages behind the mating surface (12) when the mounting leg (9) is fixed on the fastening surface (4) in order to close a snap connection, and
wherein a stop (20) is arranged on the mounting leg (9) spaced apart from the snap element in a longitudinal direction (16) of the mounting leg (9), and
wherein, when the snap connection is closed, the stop (20) bears firmly against a mating stop (13) formed on the fastening surface (4) whereby the mounting leg (9) is prevented from moving longitudinally relative to the fastening surface (4).

11. The contact support according to claim 10,
wherein the contact surface (3) and the fastening surface (4) of the busbar (2) form oppositely situated cage walls of a contact cage (1) with a rectangular hollow cross-section and are connected to each other at each of their ends by a respective cage side wall (5) running at a right angle to the contact surface (3) and to the fastening surface (4).

12. The contact support according to claim 10,
wherein a guide surface (8) situated opposite the fastening surface (4) is formed on the busbar (2), and
wherein, when the snap connection is closed, the fastening surface (4) and the guide surface (8) flank the mounting leg (9) of the contact spring (10) on opposite sides and are guided between them.

13. The contact support according to claim 12, further comprising:
a T-shaped tab (6), bent out of the fastening surface (4) of the busbar (2), with a hammer head (7) as a T cross-piece and
with a neck (11) between the hammer head (7) and the fastening surface (4) as a T longitudinal piece; and
a mounting eye (15), cut out of the mounting leg (9) of the contact spring (10),
with a hollow cross-section complementing a cross-section of the neck (11) and
with a V-shaped slot (14), converging towards the mounting eye (15), in a free end, adjoining the mounting eye (15), of the mounting leg (9) in order to form two opposite snap hooks (19) which engage behind the T-shaped tab (6) in a region of its neck (11) when the snap connection is closed,
wherein a lower side of the neck (11) forms the mating surface (12) for the two opposite snap hooks,
wherein an upper end of the mounting eye (15) forms the stop (20) and an upper side of the neck (11) forms the mating stop (13), and
wherein subsurfaces, facing the fastening surface (4) and flanking the neck (11) laterally, of the hammer head (7) form the guide surface (8) for the mounting leg (9).

14. The contact support according to claim 12, further comprising:
a latching window (21) cut free from the fastening surface (4) of the busbar (2);
a latching tab (22) bent out on the mounting leg (9) of the contact spring (10) in such a way that, when the snap connection is closed, the latching tab (22) projects into the latching window (21) and a free end of the latching tab (22) bears against an upper edge of the latching window (21) and an end side of the free end of the mounting leg (9) bears as the stop (20) against a lower end, bent out as the mating stop (13), of the fastening surface (4); and
a guide lug (23) bent out from a cage side wall (5) towards an interior of the contact cage (1) in such a way that a surface, facing the fastening surface (4), of the guide lug (23) forms the guide surface (8).

15. The contact support according to claim 14,
wherein the latching window (21) is one of two latching windows (21),
wherein the latching tab (22) is one of two latching tabs (22), and
wherein the two latching windows (21) in the fastening surface (4) of the busbar (2), the two latching tabs (22) bent out from the contact spring (10), and in each case one guide lug (23) bent out from two cage side walls (5) are arranged in each case in pairs.

16. The contact support according to claim 10, further comprising
at least one contact pin connected to the busbar (2) or one contact socket connected to the busbar as part of a plug coupling.

17. A plug connector insert with the contact support according to claim 10 and with a contact pin connected thereto or a contact socket connected thereto.

18. A plug connector with an insulating housing and with the plug connector insert according to claim 17 arranged in the insulating housing.
